(19) United States
(12) Patent Application Publication
(10) Pub. No.: US 2020/0043413 A1
(43) Pub. Date: Feb. 6, 2020

(54) PIXEL DRIVING CIRCUIT AND DISPLAY PANEL

(71) Applicant: WUHAN CHINA STAR OPTOELECTRONICS SEMICONDUCTOR DISPLAY TECHNOLOGY CO., LTD., Wuhan, Hubei (CN)

(72) Inventor: Yan XIE, Wuhan, Hubei (CN)

(21) Appl. No.: 16/091,120

(22) PCT Filed: Sep. 11, 2018
(86) PCT No.: PCT/CN2018/104931

§ 371 Date: Oct. 4, 2018

(30) Foreign Application Priority Data
Aug. 3, 2018 (CN) 201810875701.8

(51) Int. Cl. G09G 3/3258

(52) U.S. Cl. CPC G09G 3/3258; G09G 2300/0819; G09G 2320/0233; G09G 2320/045

(57) ABSTRACT

A pixel driving circuit and a display panel are provided. The pixel driving circuit includes a driving transistor, a storage capacitor, a light emitting device, a first transistor, a second transistor, a third transistor, a fourth transistor, a fifth transistor, and a sixth transistor.

### FIELD OF INVENTION

The present disclosure relates to a technical field of displays, and more particularly to a pixel driving circuit and a display panel.

### BACKGROUND OF INVENTION

Referring to FIG. 1, FIG. 1 is a schematic structural diagram of an existing pixel driving circuit. As illustrated in FIG. 1, the existing pixel driving circuit includes a light emitting device OLED, a driving transistor T2, a switch transistor T1, and a storage capacitor Cst. The storage capacitor Cst stores a threshold voltage of the driving transistor T2. A terminal of the storage capacitor Cst is coupled to a control terminal of the driving transistor T2 and a second terminal of the switch transistor T1. Another terminal of the storage capacitor Cst is coupled to a second terminal of the driving transistor T2 and an anode of the light emitting device OLED. A control terminal of the switch transistor T1 is coupled to a driving signal SCAN, and a first terminal of the switch transistor T1 is coupled to a data signal Data. A first terminal of the driving transistor T2 is coupled to a first power signal Vdd. A cathode of the light emitting device OLED is coupled to a reference signal Vss. The data signal Data is provided to the control terminal of the driving transistor T2 through the switch transistor T1, to control whether the driving transistor T2 is turned on or off, and control an amount of a current of the driving transistor T2, to control light emission of the light emitting device OLED.

A current IOLED of the light emitting device OLED when the light emitting device OLED emits light is the current of the driving transistor T2 corresponding to a gate to source voltage Vgs. The current IOLED can be expressed by the following equation: IOLED=k(Vgs−Vth)²=k(VDD−VData−|Vth|)² From the equation, in the above pixel driving circuit, the current IOLED depends on the threshold voltage Vth of the driving transistor T2. Therefore, threshold voltage variations of the driving transistor T2 would cause the light emitting device OLED to emit uneven light, affecting image quality.

### SUMMARY OF INVENTION

The present disclosure provides a pixel driving circuit and a display panel, which can compensate for threshold voltage variations of a driving transistor, increasing evenness of light emitted by a light emitting device, thereby enhancing image quality.

The present disclosure provides a pixel driving circuit including a first reset module, a second reset module, a compensation module, and a light emitting module.

The first reset module is configured to receive a second driving signal and, in response to the second driving signal, transmit a reference signal to the compensation module to reset the compensation module.

The second reset module is configured to receive the second driving signal and, in response to the second driving signal, transmit the second driving signal to the light emitting module to reset the light emitting module.

The compensation module is configured to receive a first driving signal and, in response to the first driving signal, write a data signal and perform threshold voltage compensation.

The light emitting module is configured receive a third driving signal and, in response to the third driving signal, emit light.

The first reset module includes: a third transistor.

A control terminal of the third transistor is coupled to the second driving signal, a first terminal of the third transistor is coupled to the reference signal, and a second terminal of the third transistor is coupled to the compensation module. The first driving signal, the second driving signal, and the third driving signal are all provided by an external timing controller.

In the pixel driving circuit of the present disclosure, the second reset module includes: a fourth transistor.

A control terminal and a first terminal of the fourth transistor are both coupled to the second driving signal, and a second terminal of the fourth transistor is coupled to the light emitting module.

In the pixel driving circuit of the present disclosure, the compensation module includes: a first transistor, a second transistor, a driving transistor, and a storage capacitor.

A control terminal of the driving transistor is coupled to a second terminal of the storage capacitor, a first terminal of the second transistor, and the first reset module. A first terminal of the driving transistor is coupled to a second terminal of the first transistor and the light emitting module. A second terminal of the driving transistor is coupled to a second terminal of the second transistor and the light emitting module.

A first terminal of the first transistor and a control terminal of the second transistor are both connected to the data signal.

A control terminal of the first transistor and a control terminal of the second transistor are both connected to the first driving signal.

A first terminal of the storage capacitor is coupled to the light emitting module.

In the pixel driving circuit of the present disclosure, the light emitting module includes: a fifth transistor, a sixth transistor, and a light emitting device.

A control terminal of the fifth transistor is coupled to the third driving signal, a first terminal of the fifth transistor is coupled to a first power signal, and a second terminal of the fifth transistor is coupled to the first terminal of the driving transistor.

A control terminal of the sixth transistor is coupled to the third driving signal, a first terminal of the sixth transistor is coupled to the second terminal of the driving transistor, and a second terminal of the sixth transistor is coupled to an anode of the light emitting device.

A cathode of the light emitting device is coupled to a second power signal.

In the pixel driving circuit of the present disclosure, the driving transistor is configured to determine a driving current of the pixel driving circuit. The first transistor is configured to control transmission of the data signal. The second transistor is configured to control whether the control terminal of the driving transistor and the second terminal of the driving transistor are connected or disconnected. The third transistor is configured to control transmission of the reference signal to the control terminal of the driving transistor. The fourth transistor is configured to control transmission of the second driving signal to the light emitting device. The fifth transistor is configured to control transmission of the power signal to the first terminal of the driving transistor. The sixth transistor is configured to transmit the driving current from the driving transistor to the light emitting device.

The present disclosure also provides a pixel driving circuit including a first reset module, a second reset module, a compensation module, and a light emitting module.

The first reset module is configured to receive a second driving signal and, in response to the second driving signal, transmit a reference signal to the compensation module to reset the compensation module.

The second reset module is configured to receive the second driving signal and, in response to the second driving signal, transmit the second driving signal to the light emitting module to reset the light emitting module.

The compensation module is configured to receive a first driving signal and, in response to the first driving signal, write a data signal and perform threshold voltage compensation.

The light emitting module is configured to receive a third driving signal and, in response to the third driving signal, emit light.

In the pixel driving circuit of the present disclosure, the first reset module includes: a third transistor.

A control terminal of the third transistor is coupled to the second driving signal, a first terminal of the third transistor is coupled to the reference signal, and a second terminal of the third transistor is coupled to the compensation module.

In the pixel driving circuit of the present disclosure, the second reset module includes: a fourth transistor.

A control terminal and a first terminal of the fourth transistor are both coupled to the second driving signal, and a second terminal of the fourth transistor is coupled to the light emitting module.

In the pixel driving circuit of the present disclosure, the compensation module includes a first transistor, a second transistor, a driving transistor, and a storage capacitor.

A control terminal of the driving transistor is coupled to a second terminal of the storage capacitor, a first terminal of the second transistor, and the first reset module. A first terminal of the driving transistor is coupled to a second terminal of the first transistor and the light emitting module. A second terminal of the driving transistor is coupled to a second terminal of the second transistor and the light emitting module.

A first terminal of the first transistor and a control terminal of the second transistor are both connected to the data signal.

A control terminal of the first transistor and a control terminal of the second transistor are both connected to the first driving signal.

A first terminal of the storage capacitor is coupled to the light emitting module.

In the pixel driving circuit of the present disclosure, the light emitting module includes: a fifth transistor, a sixth transistor, and a light emitting device.

A control terminal of the fifth transistor is coupled to the third driving signal, a first terminal of the fifth transistor is coupled to a first power signal, and a second terminal of the fifth transistor is coupled to the first terminal of the driving transistor.

A control terminal of the sixth transistor is coupled to the third driving signal, a first terminal of the sixth transistor is coupled to the second terminal of the driving transistor, and a second terminal of the sixth transistor is coupled to an anode of the light emitting device.

A cathode of the light emitting device is coupled to a second power signal.

In the pixel driving circuit of the present disclosure, the driving transistor is configured to determine a driving current of the pixel driving circuit. The first transistor is configured to control transmission of the data signal. The second transistor is configured to control whether the control terminal of the driving transistor and the second terminal of the driving transistor are connected or disconnected. The third transistor is configured to control transmission of the reference signal to the control terminal of the driving transistor. The fourth transistor is configured to control transmission of the second driving signal to the light emitting device. The fifth transistor is configured to control transmission of the power signal to the first terminal of the driving transistor. The sixth transistor is configured to transmit the driving current from the driving transistor to the light emitting device.

In the pixel driving circuit of the present disclosure, the first transistor to the sixth transistor are PMOS transistors, and the driving transistor is a PMOS transistor.

In the pixel driving circuit of the present disclosure, the first driving signal, the second driving signal, and the third driving signal are all provided by an external timing controller.

In the pixel driving circuit of the present disclosure, the reference signal and the second driving signal are a same signal.

In the pixel driving circuit of the present disclosure, driving timing of the pixel driving circuit includes:

a reset stage during which the control terminal of the driving transistor and the light emitting device are reset;

a compensation stage during which a threshold voltage of the driving transistor is captured and stored in the storage capacitor; and

a light emitting stage during which a driving current is generated by the pixel driving circuit and provided to the light emitting device, to drive the light emitting device to emit light for display.

In the pixel driving circuit of the present disclosure, during the reset stage, the first driving signal is a high voltage level signal, the second driving signal is a low voltage level signal, the third driving signal is a high voltage level signal, the third transistor and the fourth transistor are turned on, the reference signal is transmitted to the control terminal of the driving transistor, the second driving signal is transmitted to the anode of the light emitting device.

In the pixel driving circuit of the present disclosure, during the compensation stage, the first driving signal is a low voltage level signal, the second driving signal is a high voltage level signal, the third driving signal is a high voltage level signal, the first transistor and the second transistor are turned on, the data signal is transmitted to the second terminal of the storage capacitor through the first transistor, the driving transistor, and the second transistor. The power signal is transmitted to the first terminal of the storage capacitor. The driving transistor is turned off when a voltage difference between the control terminal of the driving transistor and the first terminal of the driving transistor is equal to the threshold voltage of the driving transistor.

In the pixel driving circuit of the present disclosure, during the light emitting stage, the first driving signal is a high voltage level signal, the second driving signal is a high voltage level signal, the third driving signal is a low voltage level signal, the fifth transistor and the sixth transistor are turned on, the power signal is transmitted to the first terminal of the driving transistor through the fifth transistor. The driving transistor is configured to determine an amount of the driving current. The sixth transistor transmits the driving current to the organic light emitting device.

The present disclosure also provides a display panel including a pixel driving circuit, wherein the pixel driving circuit includes a first reset module, a second reset module, a compensation module, and a light emitting module.

The first reset module is configured to receive a second driving signal and, in response to the second driving signal, transmit a reference signal to the compensation module to reset the compensation module.

The second reset module is configured to receive the second driving signal and, in response to the second driving signal, transmit the second driving signal to the light emitting module to reset the light emitting module.

The compensation module is configured to receive a first driving signal and, in response to the first driving signal, write a data signal and perform threshold voltage compensation.

The light emitting module is configured to receive a third driving signal and, in response to the third driving signal, emit light.

Advantages of the present disclosure are: the pixel driving circuit provided by the present disclosure may eliminate effects of the threshold voltage of the driving transistor on the driving current, resulting in light emitted by the light emitting device to be more even and stable; in addition, during the reset stage, by resetting the anode of the light emitting device using a low voltage level of the second driving signal, the anode of the light emitting device is at a lower voltage level, contributing to reduction of a bright state and a dark state of the light emitting device, thereby increasing a contrast ratio.

### DESCRIPTION OF DRAWINGS

In order to describe a technical solution in embodiments or existing technology more clearly, drawings required to be used by the embodiments or the existing technology are briefly introduced below. Obviously, the drawings in the description below are only some embodiments of the present disclosure. With respect to persons of ordinary skill in the art, under a premise that inventive efforts are not made, other drawings may be obtained based on these drawings.

FIG. 1 is a schematic structural diagram of an existing pixel driving circuit.

FIG. 2 is schematic structural diagram of a pixel driving circuit in accordance with an embodiment of the present disclosure.

FIG. 3 is a circuit principle diagram of the pixel driving circuit in accordance with an embodiment of the present disclosure.

FIG. 4 is a timing diagram of driving signals of the pixel driving circuit in accordance with an embodiment of the present disclosure.

FIGS. 5A-5C are corresponding schematic diagrams illustrating corresponding current paths of the pixel driving circuit during stages of driving timing illustrated in FIG. 3.

FIG. 6 is a circuit principle diagram of a pixel driving circuit in accordance with another embodiment of the present disclosure.

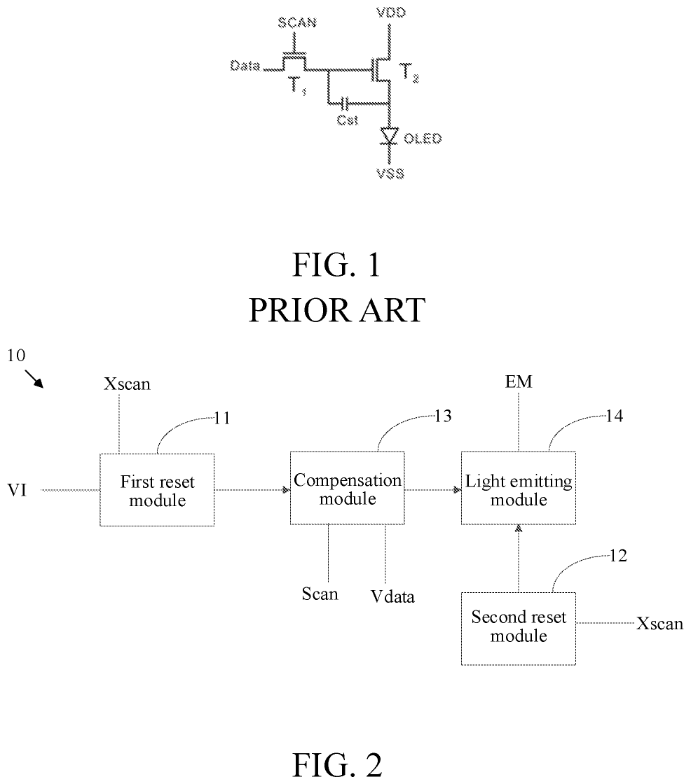

### DETAILED DESCRIPTION OF PREFERRED EMBODIMENTS

Display components provided by embodiments of the present disclosure are described in detail above. Specific examples are used herein to illustrate principles and implementation manners of the present disclosure. The description of the above embodiments is only for facilitating understanding of the present disclosure. Meanwhile, according to the idea of the present disclosure, persons skilled in the art can carry out changes to both the specific embodiments and the application scope. In summary, content of the specification should not be construed as limiting the present disclosure. The description of each embodiment below refers to respective accompanying drawing(s), so as to illustrate exemplarily specific embodiments of the present disclosure that may be practiced. Directional terms mentioned in the present disclosure, such as “upper”, “lower”, “front”, “back”, “left”, “right”, “inner”, “outer”, “side”, etc., are only directions by referring to the accompanying drawings, and thus the used directional terms are used to describe and understand the present disclosure, but the present disclosure is not limited thereto. In the drawings, structurally similar units are labeled by the same reference numerals.

Referring to FIG. 2, FIG. 2 is schematic structural diagram of a pixel driving circuit in accordance with an embodiment of the present disclosure. As illustrated in FIG. 2, the pixel driving circuit includes: a first reset module 11, a second reset module 12, a compensation module 13, and a light emitting module 14.

The first reset module 11 is configured to receive a second driving signal Xscan and, in response to the second driving signal Xscan, transmit a reference signal VI to the compensation module 13 to reset the compensation module 13.

The second reset module 12 is configured to receive the second driving signal Xscan and, in response to the second driving signal Xscan, transmit the second driving signal Xscan to the light emitting module 14 to reset the light emitting module 14.

The compensation module 13 is configured to receive a first driving signal Scan and, in response to the first driving signal Scan, write a data signal Vdata and perform threshold voltage compensation.

The light emitting module 14 is configured to receive a third driving signal EM and, in response to the third driving signal EM, emit light.

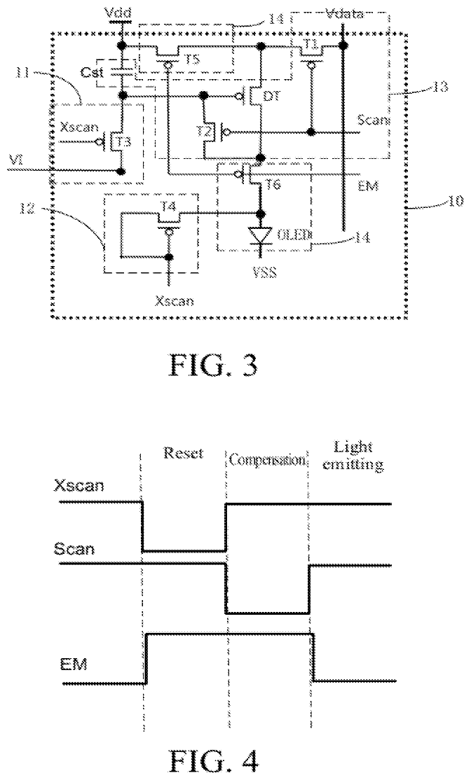

Specifically, referring to FIG. 3, FIG. 3 is a circuit principle diagram of the pixel driving circuit in accordance with an embodiment of the present disclosure. As illustrated in FIG. 3, the pixel driving circuit includes: a driving transistor DT, a storage capacitor Cst, a light emitting device OLED, a first transistor T1, a second transistor T2, a third transistor T3, a fourth transistor T4, a fifth transistor T5, and a sixth transistor T6. The driving transistor DT is configured to determine a driving current of the pixel driving circuit. The light emitting device OLED is configured to, in response to the driving current, emit light for display.

Specifically, in the present embodiment, the first transistor T1, the second transistor T2, the third transistor T3, the fourth transistor T4, the fifth transistor T5, the sixth transistor T6, and the driving transistor DT are all PMOS transistors. It is to be noted that the transistors in the pixel driving circuit provided by the embodiments of the present disclosure are all PMOS transistors, so that effects on the pixel driving circuit caused by differences between different types of transistors are avoided.

In the present embodiment, the first reset module 11 includes: the third transistor T3. A control terminal of the third transistor T3 is coupled to the second driving signal Xscan, a first terminal of the third transistor T3 is coupled to the reference signal VI, and a second terminal of the third transistor T3 is coupled to the compensation module 13.

The second reset module 12 includes: the fourth transistor T4. A control terminal and a first terminal of the fourth transistor T4 are both coupled to the second driving signal Xscan, and a second terminal of the fourth transistor T4 is coupled to the light emitting module 14.

The compensation module 13 includes: the first transistor T1, the second transistor T2, the driving transistor DT, and the storage capacitor Cst. A control terminal of the driving transistor DT is coupled to a second terminal of the storage capacitor Cst, a first terminal of the second transistor T2, and the first reset module 11. A first terminal of the driving transistor DT is coupled to a second terminal of the first transistor T1 and the light emitting module 14. A second terminal of the driving transistor DT is coupled to a second terminal of the second transistor T2 and the light emitting module 14. A first terminal of the first transistor T1, and a control terminal of the second transistor T2 are both connected to the data signal Vdata. A control terminal of the first transistor T1 and a control terminal of the second transistor T2 are both connected to the first driving signal Scan. A first terminal of the storage capacitor Cst is coupled to the light emitting module 14.

The light emitting module 14 includes: the fifth transistor T5, the sixth transistor T6, and the light emitting device OLED. A control terminal of the fifth transistor T5 is coupled to the third driving signal EM, a first terminal of the fifth transistor T5 is coupled to a first power signal Vdd, and a second terminal of the fifth transistor T5 is coupled to the first terminal of the driving transistor DT. A control terminal of the sixth transistor T6 is coupled to the third driving signal EM, a first terminal of the sixth transistor T6 is coupled to the second terminal of the driving transistor DT, and a second terminal of the sixth transistor T6 is coupled to an anode of the light emitting device OLED. A cathode of the light emitting device OLED is coupled to a second power signal VSS.

Further, the first transistor T1 is configured to control transmission of the data signal Vdata. The second transistor T2 is configured to control whether the control terminal of the driving transistor DT and the second terminal of the driving transistor DT are connected or disconnected. The third transistor T3 is configured to control transmission of the reference signal VI to the control terminal of the driving transistor DT. The fourth transistor T4 is configured to control transmission of the second driving signal Xscan to the light emitting device OLED. The fifth transistor T5 is configured to control transmission of the first power signal Vdd to the first terminal of the driving transistor DT. The sixth transistor T6 is configured to transmit the driving current from the driving transistor DT to the light emitting device OLED.

Referring to FIG. 4, FIG. 4 is a timing diagram of the driving signals of the pixel driving circuit in accordance with an embodiment of the present disclosure. In the present embodiment, the first driving signal Scan, the second driving signal Xscan, and the third driving signal EM are all provided by an external timing controller. As illustrated in FIG. 4, driving timing of the pixel driving circuit includes: a reset stage, a compensation stage, and a light emitting stage. During the reset stage, the control terminal of the driving transistor DT and the light emitting device OLED are reset. During the compensation stage, a threshold voltage of the driving transistor DT is captured and stored in the storage capacitor Cst. During the light emitting stage, the driving current is generated by the pixel driving circuit and provided to the light emitting device OLED, to drive the light emitting device OLED to emit light for display.

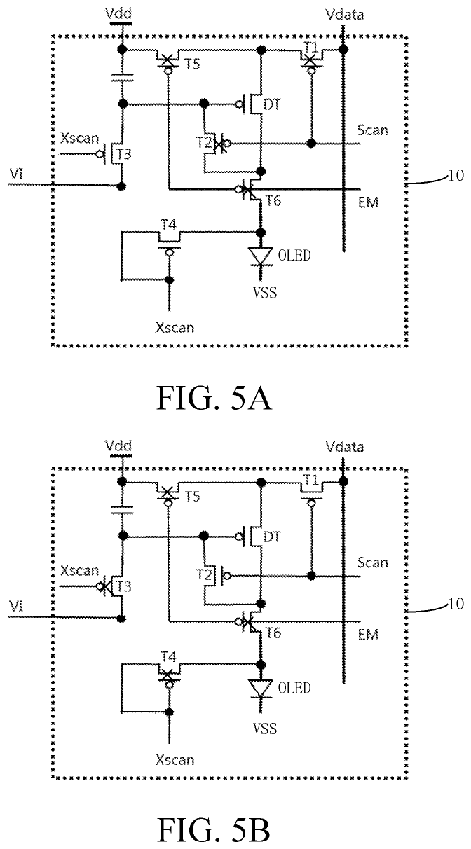

Specifically, Referring to FIGS. 5A-5C, FIGS. 5A-5C are corresponding schematic diagrams illustrating corresponding current paths of the pixel driving circuit during the stages of the driving timing illustrated in FIG. 3. First, referring to FIGS. 4 and 5A, in conjunction, during the reset stage, the first driving signal Scan is a high voltage level signal, the second driving signal Xscan is a low voltage level signal, and the third driving signal EM is a high voltage level signal. Therefore, the third transistor T3 and the fourth transistor T4 are turned on. The first transistor T1, the second transistor T2, the fifth transistor T5, and the sixth transistor T6 are turned off. At this time, the reference signal is transmitted to the control terminal of the driving transistor DT, the second driving signal Xscan is transmitted to the anode of the light emitting device OLED. It is to be noted that during the reset stage, by resetting the control terminal of the driving transistor DT using a low voltage level of the reference signal VI, and by resetting the anode of the light emitting device OLED using a low voltage level of the second driving signal Xscan, the anode of the light emitting device OLED is at a lower voltage level, contributing to reduction of a bright state and a dark state of the light emitting device OLED, thereby increasing a contrast ratio.

Next, referring to FIGS. 4 and 5B, in conjunction, during the compensation stage, the first driving signal Scan is a low voltage level signal, the second driving signal Xscan is a high voltage level signal, and the third driving signal EM is a high voltage level signal. Therefore, the first transistor T1 and the second transistor T2 are turned on. The third transistor T3, the fourth transistor T4, the fifth transistor T5, and the sixth transistor T6 are turned off. The data signal Vdata is transmitted to the second terminal of the storage capacitor Cst through the first transistor T1, the driving transistor DT, and the second transistor T2. The first power signal Vdd is transmitted to the first terminal of the storage capacitor Cst. The driving transistor DT is turned off when a voltage difference between the control terminal of the driving transistor and the first terminal of the driving transistor is equal to the threshold voltage Vth of the driving transistor DT. That is, a voltage level at the control terminal of the driving transistor DT is Vdata+|Vth|.

Finally, referring to FIGS. 4 and 5C, in conjunction, during the light emitting stage, the first driving signal Scan is a high voltage level signal, the second driving signal Xscan is a high voltage level signal, and the third driving signal EM is a low voltage level signal. Therefore, the fifth transistor T5 and the sixth transistor T6 are turned on. The first transistor T1, the second transistor T2, the third transistor T3, and the fourth transistor T4 are turned off. The first power signal Vdd is transmitted to the first terminal of the driving transistor DT through the fifth transistor T5. That is, a voltage level at the first terminal of the driving transistor DT is Vdd. At this time, the driving current IOLED corresponding to a gate to source voltage Vgs of the driving transistor DT is provided to the light emitting device OLED, causing the light emitting device OLED to emit light. The driving current IOLED generated by the driving transistor DT is expressed by the following equation.

IOLED=k(Vgs−Vth)²=k(Vdata+Vth−Vdd−Vth)2=k(Vdata−Vdd)²

In this equation, IOLED represents a current flowing through the light emitting device OLED, Vgs represents a gate to source voltage of the driving transistor DT, Vth represents a threshold voltage of the driving transistor DT, Vdata represents the data signal, and k represents a constant. As can be seen from the equation, the driving current IOLED is determined based the data signal and the power signal without considering the threshold voltage of the driving transistor DT. Therefore, the driving current IOLED stably drives the light emitting device OLED to emit light and display.

The pixel driving circuit provided by the present disclosure may eliminate effects of the threshold voltage of the driving transistor DT on the driving current, resulting in light emitted by the light emitting device OLED to be more even and stable; in addition, during the reset stage, by resetting the anode of the light emitting device OLED using a low voltage level of the second driving signal Xscan, the anode of the light emitting device OLED is at a lower voltage level, contributing to reduction of a bright state and a dark state of the light emitting device OLED, thereby increasing a contrast ratio.

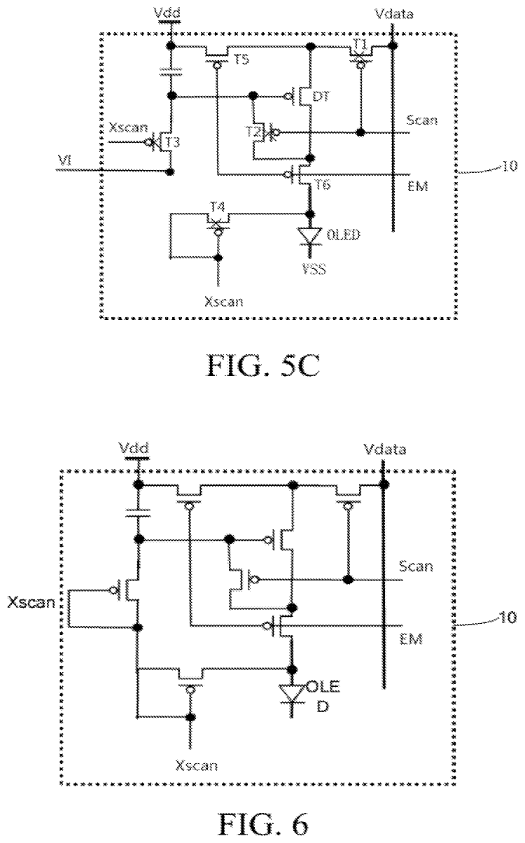

Referring to FIG. 6, FIG. 6 is a circuit principle diagram of a pixel driving circuit in accordance with another embodiment of the present disclosure. The pixel driving circuit illustrated in FIG. 6 has the following difference with respect to the pixel driving circuit illustrated in FIG. 3. In the pixel driving circuit illustrated in FIG. 6, the reference signal VI and the second driving signal Xscan are a same signal. That is, the reference signal VI and the second driving signal Xscan can be output by a same signal line, thereby decreasing a number of signal lines.

The present disclosure also provides a display panel. The display panel includes any of the aforementioned pixel driving circuits. Details of the pixel driving circuits have been provided above, and are omitted here.

In summary, although the present disclosure has been described with preferred embodiments thereof above, it is not intended to be limited by the foregoing preferred embodiments. Persons skilled in the art can carry out many changes and modifications to the described embodiments without departing from the scope and the spirit of the present disclosure. Therefore, the protection scope of the present disclosure is in accordance with the scope defined by the claims.

1. A pixel driving circuit, comprising: a first reset module, a second reset module, a compensation module, and a light emitting module;
wherein
the first reset module is configured to receive a second driving signal and, in response to the second driving signal, transmit a reference signal to the compensation module to reset the compensation module;
the second reset module is configured to receive the second driving signal and, in response to the second driving signal, transmit the second driving signal to the light emitting module to reset the light emitting module;
the compensation module is configured to receive a first driving signal and, in response to the first driving signal, write a data signal and perform threshold voltage compensation; and
the light emitting module is configured receive a third driving signal and, in response to the third driving signal, emit light; and
wherein
the first reset module comprises: a third transistor;
a control terminal of the third transistor is coupled to the second driving signal, a first terminal of the third transistor is coupled to the reference signal, and a second terminal of the third transistor is coupled to the compensation module; the first driving signal, the second driving signal, and the third driving signal are all provided by an external timing controller.

2. The pixel driving circuit of claim 1, wherein the second reset module comprises: a fourth transistor; and
a control terminal and a first terminal of the fourth transistor are both coupled to the second driving signal, and a second terminal of the fourth transistor is coupled to the light emitting module.

3. The pixel driving circuit of claim 2, wherein the compensation module comprises: a first transistor, a second transistor, a driving transistor, and a storage capacitor;
a control terminal of the driving transistor is coupled to a second terminal of the storage capacitor, a first terminal of the second transistor, and the first reset module; a first terminal of the driving transistor is coupled to a second terminal of the first transistor and the light emitting module; and a second terminal of the driving transistor is coupled to a second terminal of the second transistor and the light emitting module;
a first terminal of the first transistor is connected to the data signal;
a control terminal of the first transistor and a control terminal of the second transistor are both connected to the first driving signal; and
a first terminal of the storage capacitor is coupled to the light emitting module.

4. The pixel driving circuit of claim 3, wherein the light emitting module comprises: a fifth transistor, a sixth transistor, and a light emitting device;
a control terminal of the fifth transistor is coupled to the third driving signal, a first terminal of the fifth transistor is coupled to a first power signal, a second terminal of the fifth transistor is coupled to the first terminal of the driving transistor;
a control terminal of the sixth transistor is coupled to the third driving signal, a first terminal of the sixth transistor is coupled to the second terminal of the driving transistor, a second terminal of the sixth transistor is coupled to an anode of the light emitting device; and
a cathode of the light emitting device is coupled to a second power signal.

5. The pixel driving circuit of claim 4, wherein the driving transistor is configured to determine a driving current of the pixel driving circuit; the first transistor is configured to control transmission of the data signal; the second transistor is configured to control whether the control terminal of the driving transistor and the second terminal of the driving transistor are connected or disconnected; the third transistor is configured to control transmission of the reference signal to the control terminal of the driving transistor; the fourth transistor is configured to control transmission of the second driving signal to the light emitting device; the fifth transistor is configured to control transmission of the first power signal to the first terminal of the driving transistor; and the sixth transistor is configured to transmit the driving current from the driving transistor to the light emitting device.

6. A pixel driving circuit, comprising: a first reset module, a second reset module, a compensation module, and a light emitting module;
wherein
the first reset module is configured to receive a second driving signal and, in response to the second driving signal, transmit a reference signal to the compensation module to reset the compensation module;
the second reset module is configured to receive the second driving signal and, in response to the second driving signal, transmit the second driving signal to the light emitting module to reset the light emitting module;
the compensation module is configured to receive a first driving signal and, in response to the first driving signal, write a data signal and perform threshold voltage compensation; and
the light emitting module is configured to receive a third driving signal and, in response to the third driving signal, emit light.

7. The pixel driving circuit of claim 6, wherein the first reset module comprises: a third transistor; and
a control terminal of the third transistor is coupled to the second driving signal, a first terminal of the third transistor is coupled to the reference signal, and a second terminal of the third transistor is coupled to the compensation module.

8. The pixel driving circuit of claim 7, wherein the second reset module comprises: a fourth transistor; and
a control terminal and a first terminal of the fourth transistor are both coupled to the second driving signal, and a second terminal of the fourth transistor is coupled to the light emitting module.

9. The pixel driving circuit of claim 8, wherein the compensation module comprises: a first transistor, a second transistor, a driving transistor, and a storage capacitor;
a control terminal of the driving transistor is coupled to a second terminal of the storage capacitor, a first terminal of the second transistor, and the first reset module; a first terminal of the driving transistor is coupled to a second terminal of the first transistor and the light emitting module; and a second terminal of the driving transistor is coupled to a second terminal of the second transistor and the light emitting module;
a first terminal of the first transistor is connected to the data signal;
a control terminal of the first transistor and a control terminal of the second transistor are both connected to the first driving signal; and
a first terminal of the storage capacitor is coupled to the light emitting module.

10. The pixel driving circuit of claim 9, wherein the light emitting module comprises: a fifth transistor, a sixth transistor, and a light emitting device;
a control terminal of the fifth transistor is coupled to the third driving signal, a first terminal of the fifth transistor is coupled to a first power signal, a second terminal of the fifth transistor is coupled to the first terminal of the driving transistor;
a control terminal of the sixth transistor is coupled to the third driving signal, a first terminal of the sixth transistor is coupled to the second terminal of the driving transistor, a second terminal of the sixth transistor is coupled to an anode of the light emitting device; and
a cathode of the light emitting device is coupled to a second power signal.

11. The pixel driving circuit of claim 10, wherein the driving transistor is configured to determine a driving current of the pixel driving circuit; the first transistor is configured to control transmission of the data signal; the second transistor is configured to control whether the control terminal of the driving transistor and the second terminal of the driving transistor are connected or disconnected; the third transistor is configured to control transmission of the reference signal to the control terminal of the driving transistor; the fourth transistor is configured to control transmission of the second driving signal to the light emitting device; the fifth transistor is configured to control transmission of the first power signal to the first terminal of the driving transistor; and the sixth transistor is configured to transmit the driving current from the driving transistor to the light emitting device.

12. The pixel driving circuit of claim 10, wherein the first transistor to the sixth transistor are PMOS transistors, and the driving transistor is a PMOS transistor.

13. The pixel driving circuit of claim 6, wherein the reference signal and the second driving signal are a same signal.

14. The pixel driving circuit of claim 10, wherein driving timing of the pixel driving circuit comprises:
a reset stage during which the control terminal of the driving transistor and the light emitting device are reset;
a compensation stage during which a threshold voltage of the driving transistor is captured and stored in the storage capacitor; and
a light emitting stage during which a driving current is generated by the pixel driving circuit and provided to the light emitting device, to drive the light emitting device to emit light for display.

15. The pixel driving circuit of claim 14, wherein during the reset stage, the first driving signal is a high voltage level signal, the second driving signal is a low voltage level signal, the third driving signal is a high voltage level signal, the third transistor and the fourth transistor are turned on, the reference signal is transmitted to the control terminal of the driving transistor, the second driving signal is transmitted to the anode of the light emitting device.

16. The pixel driving circuit of claim 14, wherein during the compensation stage, the first driving signal is a low voltage level signal, the second driving signal is a high voltage level signal, the third driving signal is a high voltage level signal, the first transistor and the second transistor are turned on, the data signal is transmitted to the second terminal of the storage capacitor through the first transistor, the driving transistor, and the second transistor; the first power signal is transmitted to the first terminal of the storage capacitor; and the driving transistor is turned off when a voltage difference between the control terminal of the driving transistor and the first terminal of the driving transistor is equal to the threshold voltage of the driving transistor.

17. The pixel driving circuit of claim 14, wherein during the light emitting stage, the first driving signal is a high voltage level signal, the second driving signal is a high voltage level signal, the third driving signal is a low voltage level signal, the fifth transistor and the sixth transistor are turned on, the first power signal is transmitted to the first terminal of the driving transistor through the fifth transistor; the driving transistor is configured to determine an amount of the driving current; the sixth transistor transmits the driving current to the light emitting device.

18. A display panel, comprising: a pixel driving circuit, wherein the pixel driving circuit comprises a first reset module, a second reset module, a compensation module, and a light emitting module;
wherein the first reset module is configured to receive a second driving signal and, in response to the second driving signal, transmit a reference signal to the compensation module to reset the compensation module;
the second reset module is configured to receive the second driving signal and, in response to the second driving signal, transmit the second driving signal to the light emitting module to reset the light emitting module;
the compensation module is configured to receive a first driving signal and, in response to the first driving signal, write a data signal and perform threshold voltage compensation; and the light emitting module is configured to receive a third driving signal and, in response to the third driving signal, emit light.
